(19) United States
(12) Patent Application Publication
(10) Pub. No.: US 2014/0277685 A1
(43) Pub. Date: Sep. 18, 2014

(54) PRECISION BORING BAR AND NUMERICAL CONTROL BORING MACHINE USING THE PRECISION BORING BAR

(71) Applicant: LAI-FA CHEN, Taichung City (TW)

(72) Inventor: LAI-FA CHEN, Taichung City (TW)

(21) Appl. No.: 13/833,169

(22) Filed: Mar. 15, 2013

(51) Int. Cl. B23B 29/02; B23B 29/034

(52) U.S. Cl. CPC B23B 29/02; B23B 29/034
USPC 700/160; 408/147

(57) ABSTRACT

A precision boring bar and a numerical control boring machine using the precision boring bar are provided. The precision boring bar includes a bar body having an inner chamber therein. The inner chamber is filled with a fluid medium which is not compressed. An active diaphragm assembly and a passive diaphragm assembly are provided at two ends of the bar body and communicate with the inner chamber. The passive diaphragm assembly includes a blade seat for selectively locking a blade. When the active diaphragm assembly is activated to press inward, the blade on the passive diaphragm assembly is driven synchronously to protrude. To cooperate with the program control of the numerical control boring machine, the blade will generate micro feed during processing for the inner hole of a workpiece to form a non-round hole.

### BACKGROUND OF THE INVENTION

1. Field of the Invention

The present invention relates to a precision boring bar and a numerical control boring machine using the precision boring bar for processing a non-round curved surface.

2. Description of the Prior Art

For pin holes of some parts to bear complicated machines and heat load, the degree of the deformation of the pin axle to transmit torque is varied according to the position of the applied force. Thus, the transverse cross-section of this type of pin hole should be oval, and the ovality is varied according to the axial position of different shapes of holes, non-standard oval. The axial isoline of this type of pin hole is curviform to conform to the applied force of the pin axle. Thus, the design of this type of pin hole is a non-round hole to enhance its load ability.

A conventional apparatus to process different shapes of holes adopts an inclined main shaft to process a fixed oval at a time. It is unable to process a non-standard oval hole, let alone non-round hole, trumpet-shaped hole or the like. A developed boring machine, as disclosed in Chinese Patent No. CN200510044793.8, CN20071 001 71 39.7, changes the whole boring machine to process different shapes of holes. This will cause that the boring bar is unstable and that the rotational speed of the boring bar is lowered. The main shaft of the boring machine is driven by a drive belt, which cannot prevent the boring machine form shaking due to vibration of the drive belt. This will increase the malfunction and variation of the roughness of the surface to be processed. Furthermore, because of the aforesaid problems, it can only complete a single procedure. For a pin hole, a trumpet-shaped hole, an inward chamfer, an outward chamfer or the like, it is required to be completed by using a specific boring machine. This will increase the error for resetting and influence the precision of the whole process.

Accordingly, the inventor of the present invention has devoted himself based on his many years of practical experiences to solve these problems.

### SUMMARY OF THE INVENTION

The primary object of the present invention is to provide a precision boring bar to process different shapes of holes. The blade can be controlled exactly for micro feed when it is rotated at a high speed to achieve the demand for a stable and precise boring process.

In order to achieve the aforesaid objects and effects, the precision boring bar comprises a bar body, an active diaphragm assembly, and a passive diaphragm assembly. The bar body has an inner chamber therein. The inner chamber is filled with a fluid medium which is not compressed. The active diaphragm assembly and the passive diaphragm assembly are disposed at two ends of the bar body and communicate with the inner chamber. The active diaphragm assembly and the passive diaphragm assembly are respectively composed of at least one layer of diaphragm. The passive diaphragm assembly comprises a blade seat on a circumferential face thereof to lock a blade.

Another object of the present invention is to provide a numerical control boring machine to process different shapes of holes, with a simple mechanism to process different shapes of holes and decrease the loss and lower the cost.

In order to achieve the aforesaid objects and effects, the numerical control boring machine comprises a machine body, a saddle seat, a boring main shaft, and a numerical control system. The saddle seat is disposed on the machine body for clamping a workpiece. The saddle seat is able to move linearly along one or more axes. The boring main shaft is adapted for locking the precision boring bar and disposed on the machine body opposite the saddle seat. The boring main shaft is able to move linearly along one or more axes. The boring main shaft comprises a driving member therein for acting the active diaphragm assembly of the precision boring bar. The numerical control system comprises a program compiling module to control the saddle seat, the boring main shaft and the driving member.

### BRIEF DESCRIPTION OF THE DRAWINGS

FIG. 1 is a schematic view of the precision boring bar of the present invention;

FIG. 2 is a partial exploded view of the precision boring bar of the present invention;

FIG. 3 is another partial exploded view seen from another angle of the precision boring bar of the present invention;

FIG. 4 is a side sectional view of the precision boring bar of the present invention;

FIG. 5 is a schematic view of the numerical control boring machine using the precision boring bar of the present invention;

FIG. 6 is a side sectional view showing the direct-type connecting interface of the active diaphragm of the precision boring bar of the present invention;

FIG. 7 is a side sectional view showing the indirect-type connecting interface of the active diaphragm of the precision boring bar of the present invention;

FIG. 8 is a side sectional view showing the direct/indirect-type connecting interface of the active diaphragm of the precision boring bar of the present invention;

FIG. 9 is a side sectional view of the present invention when in use;

FIG. 10 is an end cross-sectional view of the present invention when in use;

FIG. 11 is a transverse cross-sectional view of the workpiece to be processed for a round hole;

FIG. 12 is a transverse cross-sectional view of the workpiece to be processed for an oval hole;

FIG. 13 is a transverse cross-sectional view of the workpiece to be processed for a non-standard oval hole;

FIG. 14 is an axial sectional view of the workpiece to be processed for an inward trumpet-shaped hole;

FIG. 15 is an axial sectional view of the workpiece to be processed for an outward trumpet-shaped hole;

FIG. 16 is an axial cross-sectional view of the workpiece to be processed for an arc hole;

FIG. 17 is an axial cross-sectional view of the workpiece to be processed for an stepped hole; and

FIG. 18 is a sectional view showing the workpiece to be processed for different shapes of holes, wherein (A) shows an oval section and (B) shows an arc section.

### DETAILED DESCRIPTION OF THE PREFERRED EMBODIMENTS

Embodiments of the present invention will now be described, by way of example only, with reference to the accompanying drawings.

As shown in FIG. 1 to FIG. 4, a precision boring bar comprises a bar body (10). Two ends of the bar body (10) have an active diaphragm assembly (20) and a passive diaphragm assembly (30). The precision boring bar is selectively disposed on a boring main shaft (70) of a numerical control boring machine which can rotate at a high speed, as shown in FIG. 5. Another end of the precision boring bar is selectively provided with a blade (36).

One end of the bar body (10) has a connection portion (11) which is connected to the boring main shaft (70). A circumferential face of another end of the bar body (10) has a blade seat portion (12) for connecting the blade (36). The bar body (10) has a through inner chamber (15) therein. The inner chamber (15) is filled with a fluid medium (A) which is not compressed. The connection portion (11) of the bar body (10) is formed with a disk (16) corresponding to the boring main shaft (70). The disk (16) has a plurality of counter bores (18) for screws or the like to lock the bar body (10) to the boring main shaft (70).

The active diaphragm assembly (20) is disposed at one end of the connection portion (11) of the bar body (10). The active diaphragm assembly (20) is composed of one or more layers of diaphragms (21). In this embodiment of the present invention, the active diaphragm assembly (20) has two layers of diaphragms (21). The diaphragms (21) are made of a material without ductility, such as metallic sheet, and have a prestressing force to return automatically after pushed. The active diaphragm assembly (20) comprises a central guide block (22) to connect the diaphragms (21). The guide block (22) has a connecting interface (25) on an outside thereof. The connecting interface (25) is for connection a driving member (80) on the boring main shaft (70), as shown in FIG. 5. The connecting interface (25) is selected from one of direct connection, indirect connection and direct/indirect connection. Wherein, the direct connection adopts a screw bolt (26) formed on the guide block (22) for direct engagement of the driving member (80), such that the driving member (80) can direct act the diaphragms (21) to press inward or to retract outward, as shown in FIG. 6. The indirect connection adopts the way that the driving member (80) is directly against the surface of the guide block (22), such that the driving member (80) acts the diaphragms (21) to press inward only, as shown in FIG. 7, and the diaphragms (21) returns to their original positions by elasticity. The direct/indirect connection adopts a sphere seat (28) formed on the guide block (22) and uses a sphere (29) to connect the driving member (80) indirectly, such that the driving member (80) acts the diaphragms (21) to press inward only, as shown in FIG. 8, and the diaphragms (21) returns to their original positions by elasticity and absorbs the deviation of the driving member (80).

The passive diaphragm assembly (30) is disposed at one end of the blade seat portion (15) of the bar body (10). The passive diaphragm assembly (30) is composed of one or more layers of diaphragms (31). In this embodiment of the present invention, the passive diaphragm assembly (30) has two layers of diaphragms (31). The diaphragms (31) are made of the material same as that of the diaphragms (21). The passive diaphragm assembly (30) comprises a central guide block (32) to connect the diaphragms (31). The guide block (32) comprises a blade seat (35) on an outside thereof. The blade seat (35) is adapted to lock the blade (36). The circumferential face of the bar body (10) is formed with a balance portion (38) corresponding to the blade seat portion (12). The balance portion (38) is adapted to correct the weight of the blade seat portion (12) of the bar body (10) so as to keep the dynamic balance of the precision boring bar during high-speed rotation. In an embodiment, the balance portion (38) of the present invention is a flat cut surface (39).

The bar body (10) comprises a pre-pressure adjustment unit (40) at a bottom end thereof. The pre-pressure adjustment unit (40) is used to set and adjust the prestressing force force of the fluid medium (A) in the inner chamber (15) to eliminate possible backlash so as to enhance the reliability and reaction for restoration of the active and passive diaphragm assemblies (20, 30). The bottom of the bar body (10) is formed with a threaded hole (41) communicating with the inner chamber (15). An adjustment bolt (42) is screwed to the threaded hole (41) to adjust the prestressing force force of the fluid medium (A) in the inner chamber (15).

Accordingly, the precision boring bar for processing different shapes of holes is assembled.

When in use, the precision boring bar is applied to a numerical control boring machine. As shown in FIG. 5, the numerical control boring machine comprises a machine body (5). The machine body (5) comprises a saddle seat (60) for clamping a workpiece (100) and a boring main shaft (70) for locking the precision boring bar. The saddle seat (60) and the boring main shaft (70) can move linearly along one or more of X axis, Y axis and Z axis. The boring main shaft (70) can bring the precision boring bar to rotate at a high speed. The boring main shaft (70) is provided with a driving member (80) to act the active diaphragm assembly (20) of the precision boring bar. The driving member (80) has a linkage rod (85) to connect the connecting interface (25) of the active diaphragm assembly (20). The numerical control boring machine comprises a numerical control system (90) for controlling the saddle seat (60) and the boring main shaft (70). The numerical control system (90) is selected from one of a complete system and a master/servant system. The numerical control system (90) comprises a program compiling module (91) for compiling and storing control program. The numerical control system (90) further comprises at least one servo amplifier (95) for controlling displacement of the boring main shaft (70), a servo amplifier (97) for controlling high-speed rotation of the boring main shaft (70), and a servo amplifier (96) for controlling the driving member (80). Wherein, the servo amplifier (96) can control linear displacement of the linkage rod (85) of the driving member (80) to exactly act the active diaphragm assembly (20) of the precision boring bar to control micro feed of the passive diaphragm assembly (30), as shown in FIG. 9 and FIG. 10.

To process, as shown in FIG. 5, FIG. 9 and FIG. 10, through the command of the program compiling module (91) of the numerical control system (90), the saddle seat (60) is driven to move the workpiece (100) or the boring main shaft (70) is driven to move and rotate at a high speed. Through the command of the program compiling module (91) of the numerical control system (90), the linkage rod (85) of the driving member (80) is driven for linear displacement. Through the connecting interface (25), the diaphragms (21) of the active diaphragm assembly (20) of the precision boring bar are driven synchronously. Through the fluid medium (A) in the inner chamber (15) of the bar body (10), the diaphragms (31) of the passive diaphragm assembly (30) are pushed synchronously to bring micro feed of the blade (36) of the blade seat (35) on the passive diaphragm assembly (30) during high speed rotation, as shown in FIG. 9 and FIG. 10, to bore different shapes of holes (105) for the workpiece (100) as desired, as shown in FIG. 11 to FIG. 18, to conform with the demand of size tolerance.

After processing, through the command of the program compiling module (91) of the numerical control system (90), the linkage rod (85) of the driving member (80) is driven to retract linearly, so that the diaphragms (21) of the active diaphragm assembly (20) of the precision boring bar are retracted synchronously. Through the fluid medium (A) in the inner chamber (15) of the bar body (10), the diaphragms (31) of the passive diaphragm assembly (30) are pulled back synchronously to bring the blade (36) of the blade seat (35) on the passive diaphragm assembly (30) to return to its initial position, preventing the blade (36) to rub and damage the surface of the workpiece to be processed when retracting.

The precision boring bar and the numerical control boring machine of the present invention can process different shapes of holes (105) for the workpiece. For the cross-section of different shapes of holes (105), FIG. 11 shows a round hole (105); FIG. 12 shows an oval hole (105A); and FIG. 13 shows a non-standard oval hole (105B). For the axial section of different shapes of holes (105), FIG. 14 shows an inward trumpet-shaped hole (105D); FIG. 15 shows an outward trumpet-shaped hole (105E); FIG. 16 shows an arc hole (105F); and FIG. 17 shows a stepped hole (105G). For the lateral section and axial section of different shapes of holes (105C), FIG. 18 (A) shows an oval section and FIG. 18 (B) shows an arc section.

According to the aforesaid operating explanation, the present invention can process different shapes of holes with a simple mechanism and doesn't need much load for driving and feeding. The machine tool won't shake or malfunction because of vibration. Besides, the present invention can process different shapes of holes precisionly and stably by a single working procedure. It is not necessary to use other machines for boring, so there is no error caused by resetting. The present invention enhances the precision of boring effectively.

Although particular embodiments of the present invention have been described in detail for purposes of illustration, various modifications and enhancements may be made without departing from the spirit and scope of the present invention.

Accordingly, the present invention is not to be limited except as by the appended claims.

What is claimed is:

1. A precision boring bar for processing different shapes of holes, comprising:
a bar body, two ends of the bar body respectively having a connection portion and a blade seat portion, the bar body having an inner chamber therein to communicate with the connection portion and the blade seat portion, the inner chamber being filled with a fluid medium which is not compressed;
an active diaphragm assembly, the active diaphragm assembly being disposed at the connection portion of the bar body, the active diaphragm assembly being composed of at least one layer of diaphragm, the active diaphragm assembly comprising a central guide block to connect the diaphragm, the guide block having a connecting interface on an outside thereof; and
a passive diaphragm assembly, the passive diaphragm assembly being disposed at the blade seat portion of the bar body, the passive diaphragm assembly being composed of at least one layer of diaphragm, the passive diaphragm assembly comprising a central guide block to connect the diaphragm, the guide block comprising a blade seat on an outside thereof, the blade seat being adapted to lock a blade, wherein when the active diaphragm assembly is activated, the blade on the passive diaphragm assembly is driven synchronously for micro feed.

2. The precision boring bar for processing different shapes of holes as claimed in claim 1, wherein the diaphragms of the active diaphragm assembly and the passive diaphragm assembly have a prestressing force to return automatically.

3. The precision boring bar for processing different shapes of holes as claimed in claim 1, wherein the active diaphragm assembly and the passive diaphragm assembly have two layers of diaphragms.

4. The precision boring bar for processing different shapes of holes as claimed in claim 1, wherein the bar body comprises a pre-pressure adjustment unit at a bottom end thereof corresponding to the blade seat portion to set and adjust a prestressing force of the fluid medium.

5. The precision boring bar for processing different shapes of holes as claimed in claim 1, wherein a circumferential face of the bar body is formed with a balance portion corresponding to another side of the blade seat portion to correct the weight of the blade seat portion.

6. The precision boring bar for processing different shapes of holes as claimed in claim 1, wherein the connecting interface of the active diaphragm assembly is selected from one of direct connection, indirect connection and direct/indirect connection.

7. A numerical control boring machine using the precision boring bar as claimed in claim 1, comprising:
a machine body;
a saddle seat disposed on the machine body, the saddle seat being able to move linearly along one or more axes;
a boring main shaft, the boring main shaft being disposed on the machine body opposite the saddle seat, the boring main shaft being able to move linearly along one or more axes, the boring main shaft corresponding to one end of the saddle seat to selectively lock the precision boring bar, the boring main shaft comprising a driving member therein, the driving member having a linkage rod to connect the active diaphragm assembly of the precision boring bar; and
a numerical control system, the numerical control system comprising a program compiling module, the numerical control system controlling displacement and rotation of the boring main shaft through at least one servo amplifier, the numerical control system controlling linear displacement of the linkage rod of the driving member through another servo amplifier.
